(19) United States
(12) Patent Application Publication
(10) Pub. No.: US 2026/0203817 A1
(43) Pub. Date: Jul. 16, 2026

(54) METHODS AND SYSTEMS FOR FACILITATING MANAGING A PERFORMANCE OF A PORTFOLIO

(71) Applicant: BhFS Behavioural Finance Solutions GmbH, Zürich (CH)

(72) Inventor: Enrico Giovanni De Giorgi, Bellinzona (CH)

(73) Assignee: BhFS Behavioural Finance Solutions GmbH, Zürich (CH)

(21) Appl. No.: 19/021,311

(22) Filed: Jan. 15, 2025

(51) Int. Cl. G06Q 40/06; G06Q 10/0639

(52) U.S. Cl. CPC G06Q 40/06; G06Q 10/06398

(57) ABSTRACT

A method of facilitating managing a performance of a portfolio. The method includes obtaining a historical transaction data of a historical transaction associated with a portfolio, analyzing the historical transaction data using a mathematical model, generating a behavioral bias data corresponding to the behavioral bias associated with the portfolio based on the analyzing of the historical transaction data, analyzing the behavioral bias data, generating an investor behavior impact on the performance of the portfolio based on the analyzing of the behavioral bias data, and an additional data, generating a performance report of the performance of the portfolio based on the investor behavior impact, transmitting the performance report to a device, and storing the mathematical model and the additional data.

### FIELD OF THE INVENTION

Generally, the present disclosure relates to the field of data processing. More specifically, the present disclosure relates to methods and systems for facilitating managing a performance of a portfolio.

### BACKGROUND OF THE INVENTION

Behavioral finance research provides compelling empirical evidence that both private and professional investors consistently make systematic errors that negatively impact their investment performance. These mistakes stem from behavioral heuristics, often referred to as behavioral biases, which cause investors to misestimate the economic value of their assets. Research indicates that these biases can result in a missed upside potential ranging from 2% to 6% annually—a figure referred to as the Investor Behavior Impact (IBI).

While the existence of the IBI is well-documented in academic literature, a comprehensive methodology for quantifying the impact of individual behavioral biases has yet to be established. Consequently, investors face lower performance levels, but there is a lack of quantitative assessments to identify the specific causes of these shortcomings. This gap leaves investors without clear guidance on how to enhance their decision-making processes.

The substantial cost of the detrimental impact of behavioral biases on portfolio performance often outweighs the potential benefits of active portfolio management, which seeks to generate excess returns relative to a passive benchmark.

Despite the well-documented negative impact of behavioral biases on both individual and professional investors, no existing methodology enables the precise measurement of the monetary cost of misbehavior for individual investors. Current studies offer only aggregated estimates and lack a detailed portfolio attribution framework to quantify the costs of specific behavioral biases on portfolio performance.

Therefore, there is a need for improved methods and systems for facilitating managing a performance of a portfolio that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating managing a performance of a portfolio, in accordance with some embodiments. Accordingly, the method may include a step of obtaining, using a processing device, at least one historical transaction data of at least one historical transaction associated with a portfolio. Further, the method may include a step of analyzing, using the processing device, the at least one historical transaction data using at least one mathematical model. Further, the at least one mathematical model may be based on a behavioral finance theory. Further, the at least one mathematical model may be configured for quantifying an impact of at least one behavioral bias on the performance of the portfolio. Further, the method may include a step of generating, using the processing device, at least one behavioral bias data corresponding to the at least one behavioral bias associated with the portfolio based on the analyzing of the at least one historical transaction data. Further, the method may include a step of analyzing, using the processing device, the at least one behavioral bias data. Further, the method may include a step of generating, using the processing device, an investor behavior impact (IBI) on the performance of the portfolio based on the analyzing of the at least one behavioral bias data, and at least one additional data. Further, the investor behavior impact comprised of at least one investor behavior impact portion associated with the at least one behavioral bias. Further, the method may include a step of generating, using the processing device, a performance report of the performance of the portfolio based on the investor behavior impact. Further, the method may include a step of transmitting, using a communication device, the performance report to at least one device. Further, the method may include a step of storing, using a storage device, the at least one mathematical model and the at least one additional data.

Further disclosed herein is a system for facilitating managing a performance of a portfolio, in accordance with some embodiments. Accordingly, the system may include a processing device, a communication device, and a storage device. Further, the processing device may be configured for obtaining at least one historical transaction data of at least one historical transaction associated with a portfolio. Further, the processing device may be configured for analyzing the at least one historical transaction data using at least one mathematical model. Further, the at least one mathematical model may be based on a behavioral finance theory. Further, the at least one mathematical model may be configured for quantifying an impact of at least one behavioral bias on the performance of the portfolio. Further, the processing device may be configured for generating at least one behavioral bias data corresponding to the at least one behavioral bias associated with the portfolio based on the analyzing of the at least one historical transaction data. Further, the processing device may be configured for analyzing the at least one behavioral bias data. Further, the processing device may be configured for generating an investor behavior impact on the performance of the portfolio based on the analyzing of the at least one behavioral bias data, and at least one additional data. Further, the investor behavior impact comprised of at least one investor behavior impact portion associated with the at least one behavioral bias. Further, the processing device may be configured for generating a performance report of the performance of the portfolio based on the investor behavior impact. Further, the communication device may be communicatively coupled with the processing device. Further, the communication device may be configured for transmitting the performance report to at least one device. Further, the storage device may be communicatively coupled with the processing device. Further, the storage device may be configured for storing the at least one mathematical model and the at least one additional data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a flow chart of a method 200 of facilitating managing a performance of a portfolio, in accordance with some embodiments.

FIG. 3 is a flowchart of a method 300 of facilitating managing a performance of a portfolio, in accordance with some embodiments.

FIG. 4 is a flowchart of a method 400 of facilitating managing a performance of a portfolio, in accordance with some embodiments.

FIG. 5 is a flowchart of a method 500 of facilitating managing a performance of a portfolio, in accordance with some embodiments.

FIG. 6 is a flowchart of a method 600 of facilitating managing a performance of a portfolio, in accordance with some embodiments.

FIG. 7 is a flowchart of a method 700 of facilitating managing a performance of a portfolio, in accordance with some embodiments.

FIG. 8 is a block diagram of a system 800 for facilitating managing a performance of a portfolio, in accordance with some embodiments.

FIG. 9 is a block diagram of the system 800, in accordance with some embodiments.

FIG. 10 is a block diagram of the system 800, in accordance with some embodiments.

FIG. 11 is a block diagram of the system 800, in accordance with some embodiments.

FIG. 12 is a block diagram of the system 800, in accordance with some embodiments.

FIG. 13 is a flow diagram of a method 1300 of facilitating managing a performance of a portfolio, in accordance with some embodiments.

FIG. 14 illustrates a table 1400 of a performance report of the portfolio, in accordance with some embodiments.

FIG. 15 illustrates a spider graph 1500 of the performance report of the portfolio, in accordance with some embodiments.

FIG. 16 is a block diagram of a computing device 1600 for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating managing a performance of a portfolio, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating managing a performance of a portfolio.

Further, the present disclosure describes a method for quantifying the impact of behavioral bias on investment decisions.

Further, the present disclosure describes proprietary mathematical models developed by Enrico De Giorgi, founder of BhFS Behavioral Finance Solutions GmbH. Further, the mathematical mathematical models are designed to quantify the impact of the most influential behavioral biases. These biases include overconfidence, representativeness, under-diversification, and the disposition effect-the tendency to sell positions with positive returns while holding onto those with negative returns. The models are based on over 20 years of academic research in behavioral finance.

These models are applied to investors'past transactions (ex-post), generating indicators for each bias to assess their influence. These indicators are then used to attribute the overall Investor Behavior Impact (IBI) to specific behavioral biases. The result is a unique and innovative performance attribution methodology that helps investors identify and quantify the behavioral mistakes that affected their investment performance. This approach complements traditional portfolio attribution methods, which focus on financial attributes such as sectors, countries, and currencies, by adding a behavioral dimension to the analysis.

The ex-post behavioral portfolio attribution methodology provides a comprehensive analysis of how investors'behavior impacts their performance. Key features of this methodology include:
Quantifies behavioral impact: It measures how investors'decisions affect their investment success relative to a relevant benchmark.
Outcome report: The resulting report details the influence of behavioral factors on performance, offering clear insights into decision-making patterns.
Self-directed client learning: It serves as a valuable tool for self-directed investors to identify their most common mistakes and understand their impact.
Support for relationship managers: The report also acts as a basis for relationship managers to discuss portfolio performance and behavior-driven adjustments with clients.
Systematic strategies: Quantifying the behavioral impact is critical for implementing systematic strategies to reduce the influence of biases on investment decisions.

This structured approach allows investors and managers alike to make more informed decisions by addressing behavioral tendencies.

Further, the present disclosure describes Ex-post behavioral analysis of portfolio transactions that allows to identify and measure behavioral biases and attributes their impact on portfolio performance.

Further, the present disclosure describes an ex-post behavioral analysis methodology that allows for the measurement of the monetary impact of behavioral biases at the level of individual investors. This innovative approach not only quantifies the costs associated with specific behavioral biases but also attributes them directly to portfolio performance. By identifying transactions driven by behavioral biases and assessing their impact, this methodology provides actionable insights into how such biases influence investment success.

Further, the present disclosure describes mathematical models that are founded in behavioral finance theory that allow computing on a daily basis, based on portfolio transactions, an index with values between 0 and 1 for six different behaviors observable in financial transactions: (1) portfolio concentration, (2) portfolio under-diversification, (3) excessive trading (overconfidence), (4) over-estimation of risk tolerance, (5) trend-catching (representativeness), (6) disposition effect.

Further, each index measures the strength of the corresponding observed behavior, where a value of 0 means the behavior is not present, while 1 means the behavior is strongly visible.

Each of the six above-listed behavioral traits is then attributed to portfolio performance. Briefly, the invention measures how each of the six above-listed behavioral traits affected the portfolio performance in terms of monetary loss. Further, the monetary losses are measured with respect to a benchmark. Further, the disclosed methodology allows to specify the benchmark, as well as provides default assumptions on the benchmark.

Further, the disclosed systems and methods, or methodology are three fold. First, the impact of behavioral biases is measured following portfolio attribution standards. Second, the transactions that led to a deterioration of the portfolio performance can be identified. Third, the measurement as predictor power and can be integrated with a portfolio recommendation system.

Behavioral heuristics such as overconfidence, representativeness, mental accounting, and anchoring are used by investors while making investments. Further, the gap between optimal actions and actual behaviors led by behavioral heuristics is referred to as the Investor Behavior Impact (IBI). Understanding these biases can offer several benefits, particularly in improving investment strategies and outcomes:
Improved Investment Decision-Making and Increased Self Awareness. By identifying and understanding behavioral biases, investors can become more aware of their decision-making processes. This awareness can help mitigate impulsive or emotionally-driven decisions, leading to more rational and disciplined investment choices.
Enhanced Risk Management. Behavioral biases can lead to inappropriate risk-taking, either by overestimating potential returns or underestimating risks. Recognizing these biases enables investors to adjust their risk assessments and portfolio allocations more accurately, leading to better risk management.
More Effective Portfolio Optimization. Understanding the impact of behavioral biases on past returns allows investors to refine their portfolio construction strategies. By adjusting for these biases, investors can potentially optimize the balance between risk and return, improving the overall performance of the portfolio.
Greater Consistency in Returns. Behavioral biases often lead to inconsistent investment behaviors, such as buying high and selling low. By attributing portfolio performance to these biases and taking corrective actions, investors can strive for more consistent and stable returns over time.
Enhanced Performance Attribution Analysis. Traditional performance attribution focuses on factors like asset allocation, security selection, and market timing. Including behavioral biases adds another layer of analysis, providing a more comprehensive understanding of what drives portfolio performance, both positively and negatively.

The following are the behavioral actions and the effect of the behavioral actions on the portfolio performance:
Portfolio Concentration: Further, portfolio concentration occurs when wealth is allocated to a few assets, even if there are many positions. This can limit diversification benefits, as the portfolio's performance heavily relies on just a few assets.
Portfolio Under-Diversification: A portfolio with few positions is under-diversified because it does not fully benefit from the risk reduction provided by holding a sufficiently large number of stocks. The diversification benefit comes from the fact that stock prices do not always move in the same direction. Thus, a loss in one position can be offset by a gain in another. A well-diversified portfolio should contain between 15 and 25 positions.
Excessive Trading (Overconfidence): Overconfidence bias occurs when a person is excessively confident about their own beliefs, for example, the future performance of an asset or the relevance of acquired information. Overconfidence bias can lead to excessive trading and excessive risk-taking.
Over-estimation of Risk tolerance: Risk tolerance overestimation is the tendency to overestimate one's own risk tolerance. This might lead to over-reacting to short-term losses and selling in a panic.
Disposition Effect: The disposition effect leads an investor to sell winning positions more frequently than losing positions. This behavior ignores the fundamental perspective on stocks and uses the purchasing price as the only reference.
Trend-catching (Representativeness): Representativeness heuristics consists of estimating the probability of an event based on its degree of similarity with some existing mental patterns. For example, an investor might assign a high probability to a positive trend based on a few past observations and buy assets despite no economic reason to do so.
. Others: The Investor Behavior Impact is not explained by any of the above-reported behavioral factors.

Behavioral Improvement Recommendations: Potential loss/gain from the bias will occur again along the investment decision-future focus areas and behavioral personalized recommendations. The impact on returns is classified using the following method: less than −0.5%, High: Medium: Low: The impact on returns is The impact on returns is between −1.5% and −0.5%, The impact on returns is greater than −1.5%, meaning a single bias accounts for more than a 1.5% gap.

The following are the behavioral actions and recommendations associated with the behavioral actions:
Portfolio Concentration: The following is an exemplary recommendation: “To avoid concentration in your portfolio, limit the percentage of your total investment in any single asset or sector. Aim to diversify your investments across various industries and asset classes. Regularly review and rebalance your portfolio to maintain diversification and ensure it aligns with your risk tolerance.”
Portfolio Under-diversification: The following is an exemplary recommendation: “To diversify your portfolio, spread your investments across various asset classes, such as stocks, bonds, real estate, and commodities. Within each class, choose investments from different sectors and geographic regions. A properly diversified portfolio requires at least between 15 and 20 positions. Regularly review and rebalance your portfolio to maintain your desired level of diversification.”
Excessive Trading (Overconfidence): The following is an exemplary recommendation: “Verify if the information on which you intend to act by buying or selling your assets is accurate. Sometimes information seems relevant simply because it is easily available or grabs your attention as it appears strong and unidirectional. However, it is important to be disciplined and seek diverse perspectives based on statistical evidence.”
Over-estimation of Risk Tolerance: The following is an exemplary recommendation: “Reduce the risk of your portfolio if you do not feel comfortable with the losses or the volatility you have faced so far. While selling some positions to address temporary losses or increased volatility might seem appealing, it can limit your upside potential. In contrast, staying committed to your strategic asset allocation is crucial for achieving your desired performance. Your strategic asset allocation should be based on your risk tolerance, ability, and investment goals and thus properly account for your preferences and expectations.”
Disposition Effect: The following is an exemplary recommendation: “Selling winning positions and keeping losing ones might seem appealing because it feels like locking in gains while avoiding realized losses. However, this behavior, known as the disposition effect, overlooks the true economic value of your assets. Winning positions might still have significant upside potential while losing positions could incur even greater losses. It's crucial to be disciplined and seek diverse perspectives based on statistical evidence when deciding whether to sell a position. The purchase price doesn't necessarily reflect the economic value of your assets and can be very misleading.”
Trend-catching (Representativeness): The following is an exemplary recommendation: “Short-term positive or negative trends do not necessarily indicate that markets will continue to generate similar returns in the future. Avoid basing your investment decisions on these short-term movements. Instead, be disciplined and seek diverse perspectives based on statistical evidence. Overreacting to short-term trends can lead to buying at high prices and selling at low prices, resulting in average losses.”

Further, the present disclosure describes a method for quantifying the impact of behavioral biases on investment performance. Further, the method may include: (a) developing mathematical models to quantify the impact of specific behavioral biases selected from the group consisting of portfolio concentration, excessive trading (overconfidence), trend-catching (representativeness), over-estimation of risk tolerance, portfolio under-diversification, and the disposition effect; (b) applying the mathematical models to an investor's historical transaction data to generate indicators for each of the specific behavioral biases; (c) calculating an overall Investor Behavior Impact (IBI) based on the generated indicators; (d) attributing portions of the overall IBI to each of the specific behavioral biases based on the indicators; (e) generating a performance attribution report that details the influence of the specific behavioral biases on the investor's investment performance; and (f) providing the performance attribution report to the investor or a relationship manager to facilitate understanding of decision-making patterns and to support behavior-driven adjustments in investment strategies.

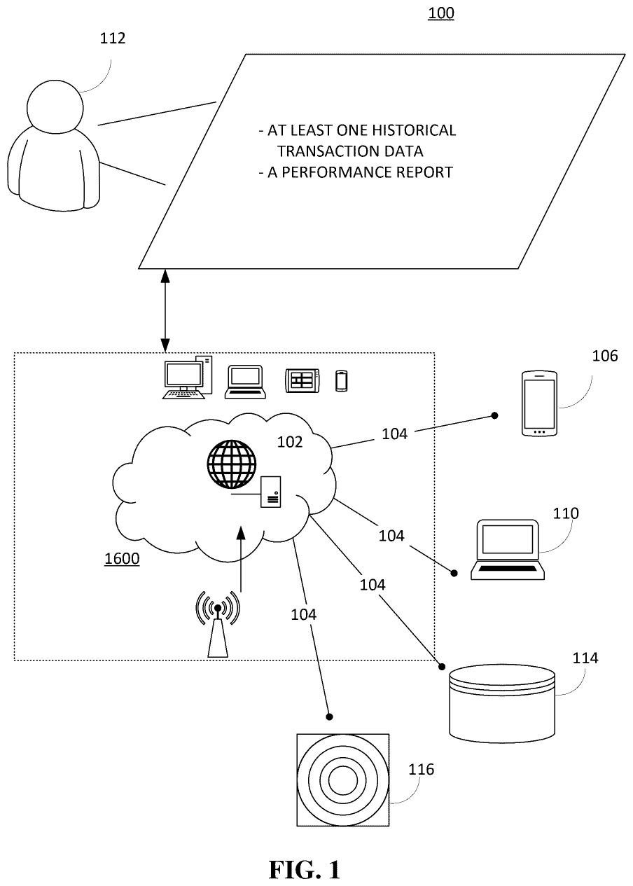

FIG. 1 is an illustration of an online platform 100 consistent with various embodiments of the present disclosure. By way of non-limiting example, the online platform 100 to facilitate managing a performance of a portfolio may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, investors, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1600.

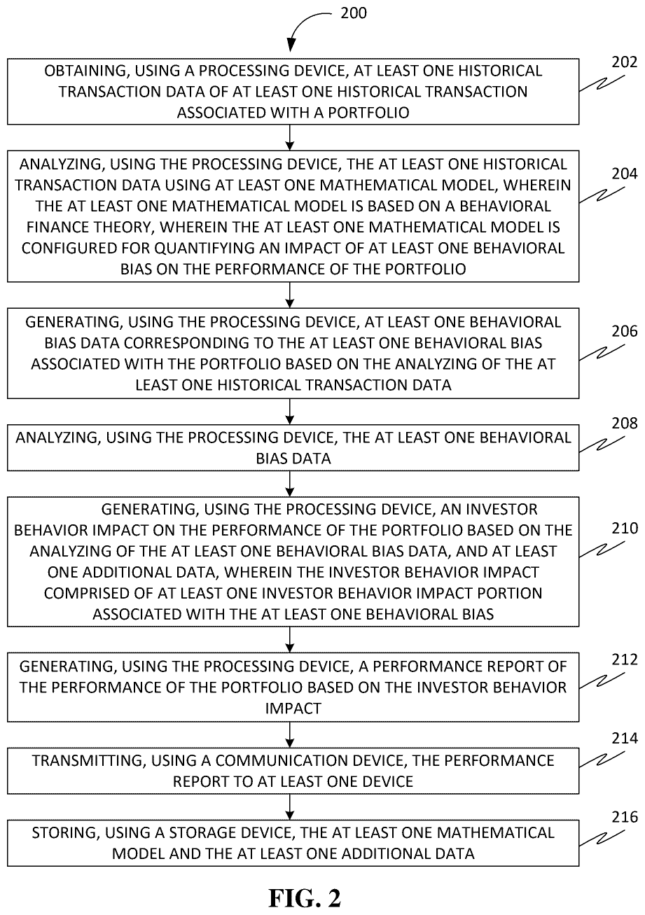

FIG. 2 is a flow chart of a method 200 of facilitating managing a performance of a portfolio, in accordance with some embodiments. Accordingly, at 202, the method 200 may include obtaining, using a processing device, at least one historical transaction data of at least one historical transaction associated with a portfolio. Further, the at least one historical transaction may include at least one investment statement. Further, the at least one historical transaction may include a number of historical portfolio transactions. Further, the at least one historical transaction may include one or more transactions associated with a financial instrument, a financial security, a financial fund, a financial asset, etc., for at least one investment. Further, the at least one historical transaction corresponds to one or more transactions made by an investor for one or more investments. Further, the at least one historical transaction data may include an identifier of the financial instrument, the financial security, the financial fund, the financial asset, etc. held by the investor, a value of the financial instrument, the financial security, the financial fund, the financial asset, etc. held by the investor, a type of the financial instrument, the financial security, the financial fund, the financial asset, etc. held by the investor, an investment date for the financial instrument, the financial security, the financial fund, the financial asset, etc. purchased by the investor, a disinvestment data for the financial instrument, the financial security, the financial fund, the financial asset, etc. sold by the investor, etc. Further, the investor may include an individual, an institution, an organization, etc. Further, the portfolio may include a financial portfolio, an investment portfolio, etc. Further, the obtaining of the at least one historical transaction data may include receiving the at least one historical transaction data from at least one device, extracting the at least one historical transaction data from the at least one device, retrieving the at least one historical transaction data from the at least one device, etc. Further, the at least one device may include a user device, a client device, a computing device, a data source device, etc. Further, in an embodiment, the obtaining of the at least one historical transaction data may include obtaining the at least one historical transaction data from at least one device through at least one network. Further, the at least one network may include a wired communication network, a wireless communication network, etc.

Further, at 204, the method 200 may include analyzing, using the processing device, the at least one historical transaction data using at least one mathematical model. Further, the at least one mathematical model may be based on a behavioral finance theory. Further, the at least one mathematical model may be configured for quantifying an impact of at least one behavioral bias on the performance of the portfolio. Further, each of the at least one mathematical model corresponds to each of the at least one behavioral bias respectively.

Further, the quantifying of the impact may include quantifying an impact of each of at least one behavioral bias by each of the at least one mathematical model respectively corresponding to each of the at least one behavioral bias. Further, the at least one behavioral bias may include a portfolio concentration (concentration), a portfolio under-diversification, an excessive trading (such as overconfidence), an over-estimation of risk tolerance (risk toleration overestimation), a trend-catching (such as representativeness), a disposition effect, etc. Further, the at least one behavioral bias may correspond to at least one behavioral trait of the investor. Further, the analyzing of the at least one historical transaction data may include executing the at least one mathematical model by inputting the at least one historical transaction data. Further, the at least one mathematical model may be trained using a supervised training method.

Further, at 206, the method 200 may include generating, using the processing device, at least one behavioral bias data corresponding to the at least one behavioral bias associated with the portfolio based on the analyzing of the at least one historical transaction data. Further, the at least one behavioral bias data may include a presence of the at least one behavioral bias in the portfolio, an impact of the at least one behavioral bias on the performance of the portfolio, etc.

Further, at 208, the method 200 may include analyzing, using the processing device, the at least one behavioral bias data.

Further, at 210, the method 200 may include generating, using the processing device, an investor behavior impact (IBI) on the performance of the portfolio based on the analyzing of the at least one behavioral bias data, and at least one additional data. Further, the investor behavior impact comprised of at least one investor behavior impact portion associated with the at least one behavioral bias. Further, the investor behavior impact is a measure of a difference in a cumulative return between the portfolio and a benchmark. Further, the at least one additional data may include a benchmark, a financial market data, a portfolio data, etc.

Further, at 212, the method 200 may include generating, using the processing device, a performance report of the performance of the portfolio based on the investor behavior impact. Further, the performance report may include a value of the investor behavior impact, a value of the at least one investor behavior impact portion corresponding to the at least one behavioral bias, etc. Further, the performance report may include one or more visual representations of the value of the investor behavior impact, the value of the at least one investor behavior impact portion corresponding to the at least one behavioral bias, etc.

Further, the one or more visual representations may include a bar graph, a spider chart, etc. Further, the performance report may include a report, etc. Further, the performance report may include at least one recommendation, at least one insight, at least one behavioral insight, etc., for mitigating the at least one behavioral bias in the portfolio.

Further, at 214, the method 200 may include transmitting, using a communication device, the performance report to at least one device (such as at least one device 902). Further, the at least one device may include a user device, a client device, a computing device, a data source device, etc.

Further, at 216, the method 200 may include storing, using a storage device, the at least one mathematical model and the at least one additional data.

Further, in some embodiments, each of the at least one behavioral bias data may include at least one index corresponding to the at least one behavioral bias. Further, each of the at least one index takes a value ranging between 0 and 1 for each of the at least one behavioral bias respectively. Further, the value of each of the at least one index indicates a degree of a strength of each of the at least one behavioral bias in the portfolio. Further, 0 means that the at least one behavior is absent in the portfolio, and 1 means that the at least one behavior is maximally present in the portfolio.

Further, in some embodiments, the at least one mathematical model may be trained for detecting at least one pattern in the at least one historical transaction data indicative of a presence of the at least one behavioral bias and at least one pattern characteristic of the at least one pattern indicative of a characteristic of the at least one behavioral bias. Further, the at least one pattern corresponds to at least one feature in the at least one historical data, and the at least one pattern characteristic corresponds to at least one feature characteristic of the at least one feature. Further, the characteristic of the at least one behavioral bias may include a prevalence of the at least one behavioral bias, an occurrence frequency of the at least one behavioral bias, a combination of the at least one behavioral bias, etc. Further, the presence of the at least one behavioral bias and the characteristic of the at least one behavioral bias correspond to the impact of the at least one behavioral bias. Further, the impact of the at least one behavioral bias may be quantified based on the presence of the at least one behavioral bias and the characteristic of the at least one behavioral bias. Further, the at least one mathematical model may be trained based on at least one training data. Further, the at least one training data may include at least one transaction data of at least one transaction associated with at least one portfolio. Further, the generating of the at least one behavioral bias data may be based on the detecting the at least one pattern and the at least one characteristic of the at least one pattern associated with the at least one behavioral bias. Further, the at least one pattern may include at least one data pattern. Further, in an embodiment, the at least one mathematical model may include at least one trained mathematical model. Further, the at least one mathematical model may be convolutional neural networks (CNNs), recurrent neural networks (RNNs), long short-term memory, support vector machines, decision trees, etc. Further, in an embodiment, the at least one mathematical model may include one or more algorithms, one or more equations, one or more functions, etc. Further, in an embodiment, the analyzing of the at least one historical transaction data using the at least one mathematical model may include segmenting the at least one historical transaction data into a plurality of historical transaction data portions associated with a plurality of transaction characteristics. Further, the plurality of transaction characteristics a transaction type, an asset identifier, a transaction amount, a payment mode, etc. Further, the analyzing of the at least one historical transaction data using the at least one mathematical model may include analyzing a plurality of historical transaction data portions using a plurality of mathematical models respectively corresponding to the plurality of historical transaction data portions based on the segmenting. Further, each of the plurality of mathematical models may be configured for detecting a pattern in each of the plurality of historical transaction data portions corresponding to the at least one behavioral bias. Further, the plurality of mathematical models may be disparate, distinct, different, etc. from each other. Further, the analyzing of the at least one historical transaction data using the at least one mathematical model may include obtaining a plurality of outputs from the plurality of mathematical models based on the analyzing of the plurality of historical transaction data portions using the plurality of mathematical models. Further, the obtaining of the plurality of outputs may be based on the pattern. Further, the generating the at least one behavioral data may be based on the plurality of outputs.

In further embodiments, the method 200 may include determining, using the processing device, at least one effect of each of the at least one behavioral bias in the performance of the portfolio based on the analyzing of the at least one historical transaction data and the investor behavior impact for each of the at least one behavioral bias. Further, the generating of the performance report may be based on the at least one effect. Further, the at least one effect may include a monetary loss, a percentage of the impact, a bias tendency, etc.

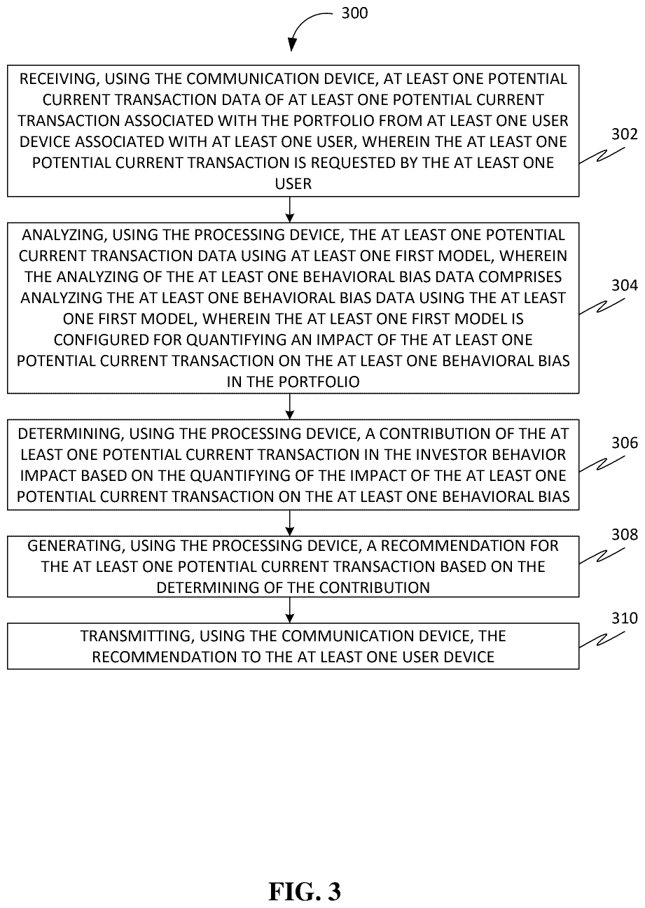

FIG. 3 is a flowchart of a method 300 of facilitating managing a performance of a portfolio, in accordance with some embodiments. Accordingly, at 302, the method 300 may include receiving, using the communication device, at least one potential current transaction data of at least one potential current transaction associated with the portfolio from at least one user device (such as at least one user device 1002) associated with at least one user. Further, the at least one potential current transaction may be requested by the at least one user. Further, the at least one user device may include a client device, a computing device, etc. Further, the at least one user may include an investor. Further, the at least one potential current transaction may include a transaction the at least one user wants to make.

Further, at 304, the method 300 may include analyzing, using the processing device, the at least one potential current transaction data using at least one first model. Further, the analyzing of the at least one behavioral bias data may include analyzing the at least one behavioral bias data using the at least one first model. Further, the at least one first model may be configured for quantifying an impact of the at least one potential current transaction on the at least one behavioral bias in the portfolio. Further, the at least one first model may include a machine learning model, a mathematical model, etc. Further, the at least one first model may be convolutional neural networks (CNNs), recurrent neural networks (RNNs), long short-term memory, support vector machines, decision trees, etc.

Further, at 306, the method 300 may include determining, using the processing device, a contribution of the at least one potential current transaction in the investor behavior impact based on the quantifying of the impact of the at least one potential current transaction on the at least one behavioral bias. Further, the contribution may include a degree of contribution ranging from a minimum threshold value to either a maximum positive threshold value or a maximum negative threshold value. Further, the at least one potential current transaction has no contribution to the investor behavior impact for the minimum threshold value. Further, the at least one potential current transaction has a maximum positive contribution to the investor behavior impact for the maximum positive threshold value.

Further, the at least one potential current transaction has a maximum negative contribution to the investor behavior impact for the maximum negative threshold value.

Further, at 308, the method 300 may include generating, using the processing device, a recommendation for the at least one potential current transaction based on the determining of the contribution. Further, the recommendation may include an affirmation for making the at least one potential current transaction, a negation for making the at least one potential current transaction, etc.

Further, at 310, the method 300 may include transmitting, using the communication device, the recommendation to the at least one user device.

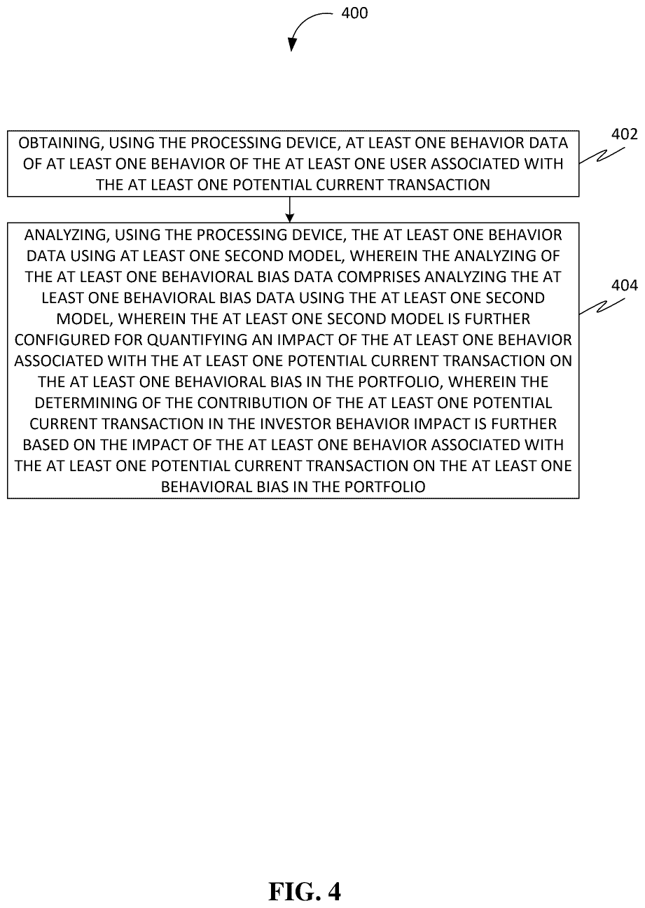

FIG. 4 is a flowchart of a method 400 of facilitating managing a performance of a portfolio, in accordance with some embodiments. Accordingly, at 402, the method 400 may include obtaining, using the processing device, at least one behavior data of at least one behavior of the at least one user associated with the at least one potential current transaction. Further, the at least one behavior data characterizes the at least one behavior of the at least one user. Further, the at least one behavior may include a behavior trait of the at least one user. Further, the at least one behavior may include agreeableness, impulsiveness, optimism, pessimism, risk-taking, patience, competitiveness, etc.

Further, at 404, the method 400 may include analyzing, using the processing device, the at least one behavior data using at least one second model. Further, the analyzing of the at least one behavioral bias data may include analyzing the at least one behavioral bias data using the at least one second model. Further, the at least one second model may be further configured for quantifying an impact of the at least one behavior associated with the at least one potential current transaction on the at least one behavioral bias in the portfolio. Further, the determining of the contribution of the at least one potential current transaction in the investor behavior impact may be further based on the impact of the at least one behavior associated with the at least one potential current transaction on the at least one behavioral bias in the portfolio. Further, the at least one second model may include a machine learning model, a mathematical model, etc. Further, the at least one second model may be convolutional neural networks (CNNs), recurrent neural networks (RNNs), long short-term memory, support vector machines, decision trees, etc.

Further, in some embodiments, the analyzing of the at least one behavior data may include analyzing the at least one behavior data using at least one third model. Further, the analyzing of the at least one potential current transaction data may include analyzing of the at least one potential current transaction data using the at least one third model. Further, the at least one third model may be configured for quantifying an impact of the at least one behavior on the at least one potential current transaction. Further, the method 400 may include determining, using the processing device, a likelihood of the at least one behavior affecting the at least one potential current transaction based on the quantifying of the impact of the at least one behavior on the at least one potential current transaction on the at least one behavioral bias in the portfolio. Further, the generating of the recommendation may be further based on the determining of the likelihood of the at least one behavior affecting the at least one potential current transaction. Further, the at least one third model may include a machine learning model, a mathematical model, etc. Further, the at least one third model may be convolutional neural networks (CNNs), recurrent neural networks (RNNs), long short-term memory, support vector machines, decision trees, etc.

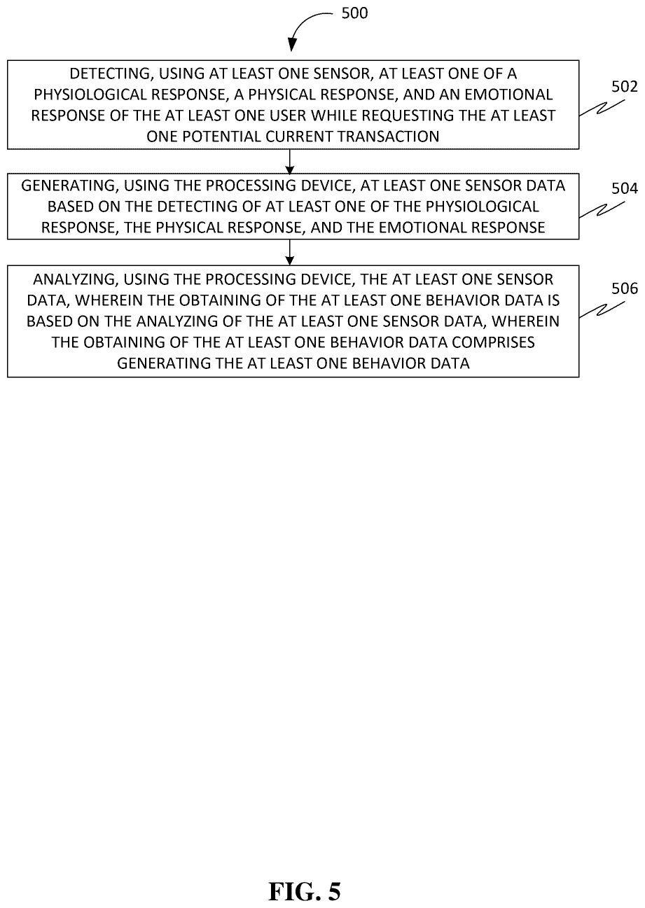

FIG. 5 is a flowchart of a method 500 of facilitating managing a performance of a portfolio, in accordance with some embodiments. Accordingly, at 502, the method 500 may include detecting, using at least one sensor, at least one of a physiological response, a physical response, and an emotional response of the at least one user while requesting the at least one potential current transaction. Further, at least one of the physiological response, the physical response, and the emotional response may include a voluntary response, an involuntary response, a reflexive response, etc. Further, the physiological response may include a change in a heartbeat, a change in a breathing rate, a change in a blood pressure, sweating, a change of pupil, a change in body temperature, etc. Further, the physical response may include a change in blinking, a gesture, a facial gesture, a facial expression, an utterance, etc. Further, the emotional response may include an increase in heart rate, an increase in sweating, an increase in blood pressure, a dilation of pupil, an increase and decrease in heart rate variability, etc. Further, the at least one sensor (such as the at least one sensor 1102) may include a visible light sensor, an infrared light sensor, an ultraviolet light sensor, a microphone, a heartbeat sensor, a temperature sensor, a galvanic skin response sensor, an electrocardiogramansor, a blood pressure sensor, a motion sensor, an eye tracking sensor, a spirometer, etc. Further, the detecting of at least one of the physiological response, the physical response, and the emotional response may be initiated based on the receiving of the he at least one potential current transaction data.

Further, at 504, the method 500 may include generating, using the processing device, at least one sensor data based on the detecting of at least one of the physiological response, the physical response, and the emotional response.

Further, at 506, the method 500 may include analyzing, using the processing device, the at least one sensor data. Further, the obtaining of the at least one behavior data may be based on the analyzing of the at least one sensor data. Further, the obtaining of the at least one behavior data may include generating the at least one behavior data.

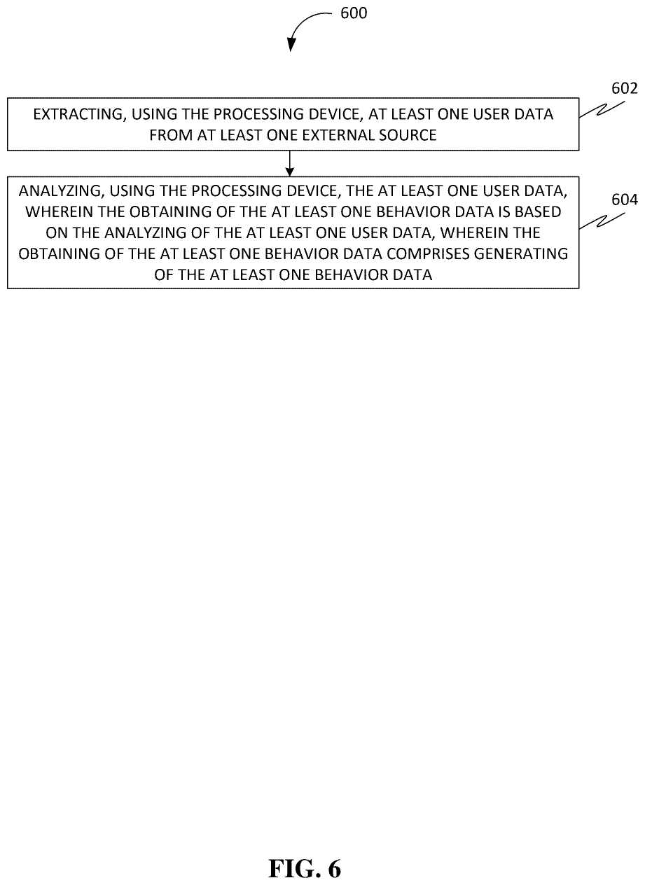

FIG. 6 is a flowchart of a method 600 of facilitating managing a performance of a portfolio, in accordance with some embodiments. Accordingly, at 602, the method 600 may include extracting, using the processing device, at least one user data from at least one external source. Further, the at least one user data may include a personal information, a social information, a financial information, etc. Further, the at least one user data may include at least one social media activity of the at least one user on at least one social media platform. Further, the at least one external source (such as the at least one external source 1202) may include at least one external database, at least one data source, at least one social media platform server, etc. Further, the extracting of the at least one user data may include obtaining the at least one user data from one or more online resources. Further, the one or more online resources may include webpages, websites, emails, social media websites, etc.

Further, at 604, the method 600 may include analyzing, using the processing device, the at least one user data. Further, the obtaining of the at least one behavior data may be based on the analyzing of the at least one user data. Further, the obtaining of the at least one behavior data may include generating of the at least one behavior data.

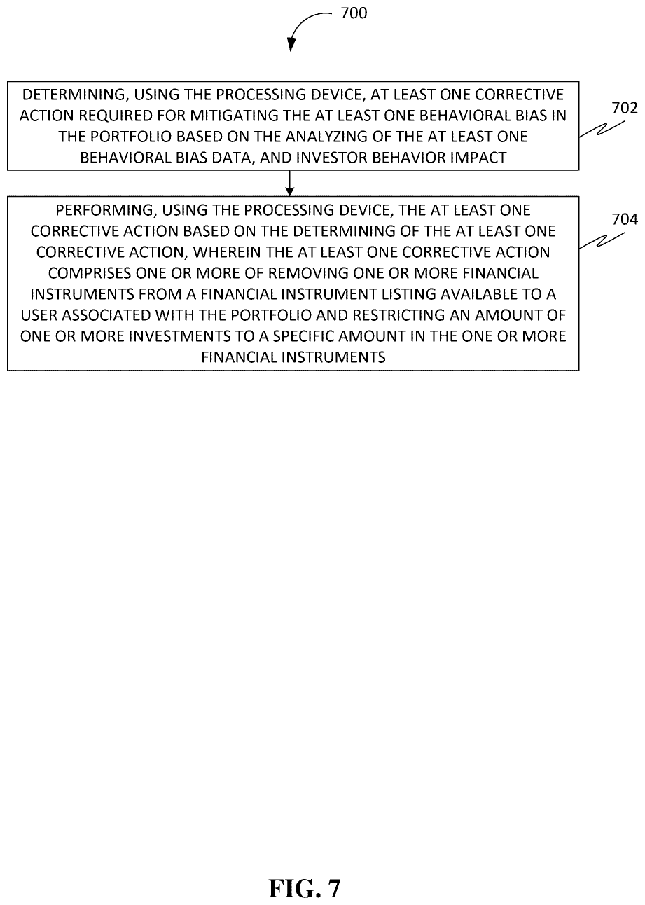

FIG. 7 is a flowchart of a method 700 of facilitating managing a performance of a portfolio, in accordance with some embodiments. Accordingly, at 702, the method 700 may include determining, using the processing device, at least one corrective action required for mitigating the at least one behavioral bias in the portfolio based on the analyzing of the at least one behavioral bias data, and investor behavior impact.

Further, at 704, the method 700 may include performing, using the processing device, the at least one corrective action based on the determining of the at least one corrective action. Further, the at least one corrective action may include one or more of removing one or more financial instruments from a financial instrument listing available to a user associated with the portfolio and restricting an amount of one or more investments to a specific amount in the one or more financial instruments. Further, the one or more financial instruments may include one or more specific financial instrument types, one or more specific financial instrument offering entities, etc. Further, the one or more financial instruments may include one or more equity instruments (stocks) of one or more companies, one or more debt instruments (bonds) of one or more of companies, governments, and organizations, one or more derivative instruments, one or more money instruments, one or more foreign exchange instruments, one or more commodities, one or more investment funds, etc. Further, the financial instrument listing may include a list of a plurality of financial instruments listed on at least one application. Further, the list provides a plurality of investment options for the at least one user through the plurality of financial instruments. Further, the list may be dynamically updated in real time. Further, the performing of the at least one corrective action may include updating the list by at least one of removing the one or more financial instruments from the list and updating at least one amount limit for investing in the one or more financial instruments. Further, the at least one application may be hosted on a local computing device, a shared computing device, a server, etc. Further, the at least one application may include a web based application (website).

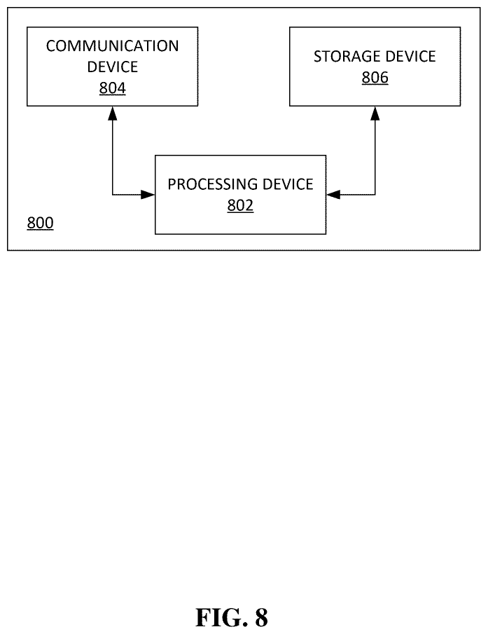

FIG. 8 is a block diagram of a system 800 for facilitating managing a performance of a portfolio, in accordance with some embodiments. Accordingly, the system 800 may include a processing device 802, a communication device 804, and a storage device 806.

Further, the processing device 802 may be configured for obtaining at least one historical transaction data of at least one historical transaction associated with a portfolio. Further, the processing device 802 may be configured for analyzing the at least one historical transaction data using at least one mathematical model. Further, the at least one mathematical model may be based on a behavioral finance theory. Further, the at least one mathematical model may be configured for quantifying an impact of at least one behavioral bias on the performance of the portfolio. Further, the processing device 802 may be configured for generating at least one behavioral bias data corresponding to the at least one behavioral bias associated with the portfolio based on the analyzing of the at least one historical transaction data. Further, the processing device 802 may be configured for analyzing the at least one behavioral bias data. Further, the processing device 802 may be configured for generating an investor behavior impact on the performance of the portfolio based on the analyzing of the at least one behavioral bias data, and at least one additional data. Further, the investor behavior impact comprised of at least one investor behavior impact portion associated with the at least one behavioral bias. Further, the processing device 802 may be configured for generating a performance report of the performance of the portfolio based on the investor behavior impact.

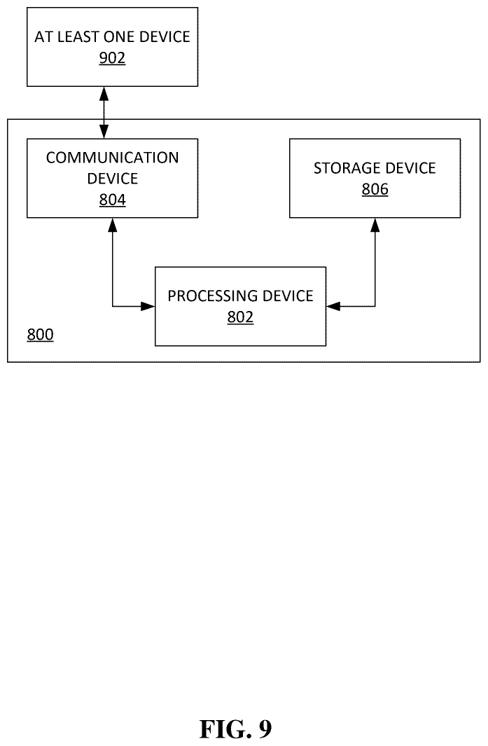

Further, the communication device 804 may be communicatively coupled with the processing device 802. Further, the communication device 804 may be configured for transmitting the performance report to at least one device 902, as shown in FIG. 9.

Further, the storage device 806 may be communicatively coupled with the processing device 802. Further, the storage device 806 may be configured for storing the at least one mathematical model and the at least one additional data.

Further, in some embodiments, each of the at least one behavioral bias data may include at least one index corresponding to the at least one behavioral bias. Further, each of the at least one index takes a value ranging between 0 and 1 for each of the at least one behavioral bias respectively. Further, the value of each of the at least one index indicates a degree of a strength of each of the at least one behavioral bias in the portfolio.

Further, in some embodiments, the at least one mathematical model may be trained for detecting at least one pattern in the at least one historical transaction data indicative of a presence of the at least one behavioral bias and at least one pattern characteristic of the at least one pattern indicative of a characteristic of the at least one behavioral bias. Further, the presence of the at least one behavioral bias and the characteristic of the at least one behavioral bias correspond to the impact of the at least one behavioral bias. Further, the at least one mathematical model may be trained based on at least one training data. Further, the at least one training data may include at least one transaction data of at least one transaction associated with at least one portfolio. Further, the generating of the at least one behavioral bias data may be further based on the detecting the at least one pattern and the at least one characteristic of the at least one pattern associated with the at least one behavioral bias.

Further, in some embodiments, the processing device 802 may be further configured for determining at least one effect of each of the at least one behavioral bias in the performance of the portfolio based on the analyzing of the at least one historical transaction data and the investor behavior impact for each of the at least one behavioral bias. Further, the generating of the performance report may be further based on the at least one effect.

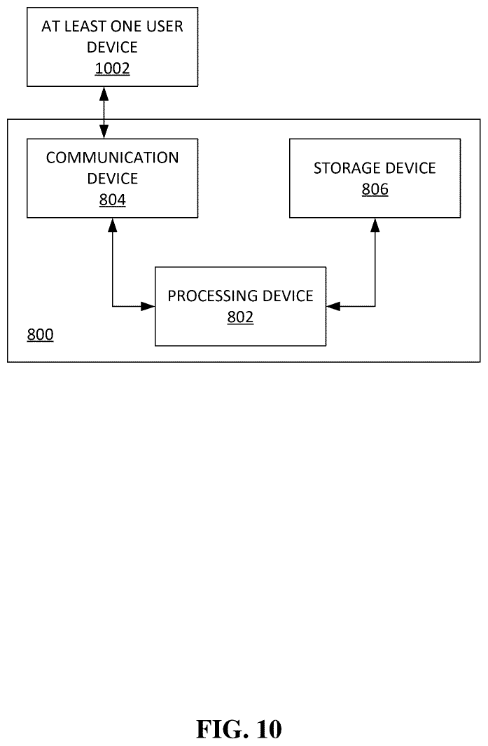

Further, in some embodiments, the communication device 804 may be further configured for receiving at least one potential current transaction data of at least one potential current transaction associated with the portfolio from at least one user device 1002, as shown in FIG. 10, associated with at least one user. Further, the at least one potential current transaction may be requested by the at least one user. Further, the communication device 804 may be configured for transmitting a recommendation to the at least one user device 1002. Further, the processing device 802 may be further configured for analyzing the at least one potential current transaction data using at least one first model. Further, the analyzing of the at least one behavioral bias data may include analyzing the at least one behavioral bias data using the at least one first model. Further, the at least one first model may be configured for quantifying an impact of the at least one potential current transaction on the at least one behavioral bias in the portfolio. Further, the processing device 802 may be configured for determining a contribution of the at least one potential current transaction in the investor behavior impact based on the quantifying of the impact of the at least one potential current transaction on the at least one behavioral bias. Further, the processing device 802 may be configured for generating the recommendation for the at least one potential current transaction based on the determining of the contribution.

Further, in an embodiment, the processing device 802 may be further configured for obtaining at least one behavior data of at least one behavior of the at least one user associated with the at least one potential current transaction. Further, the processing device 802 may be configured for analyzing the at least one behavior data using at least one second model. Further, the analyzing of the at least one behavioral bias data may include analyzing the at least one behavioral bias data using the at least one second model. Further, the at least one second model may be further configured for quantifying an impact of the at least one behavior associated with the at least one potential current transaction on the at least one behavioral bias in the portfolio. Further, the determining of the contribution of the at least one potential current transaction in the investor behavior impact may be further based on the impact of the at least one behavior associated with the at least one potential current transaction on the at least one behavioral bias in the portfolio.

Further, in an embodiment, the analyzing of the at least one behavior data further may include analyzing the at least one behavior data using at least one third model. Further, the analyzing of the at least one potential current transaction data further may include analyzing of the at least one potential current transaction data using the at least one third model. Further, the at least one third model may be configured for quantifying an impact of the at least one behavior on the at least one potential current transaction. Further, the processing device 802 may be further configured for determining a likelihood of the at least one behavior affecting the at least one potential current transaction based on the quantifying of the impact of the at least one behavior on the at least one potential current transaction on the at least one behavioral bias in the portfolio. Further, the generating of the recommendation may be further based on the determining of the likelihood of the at least one behavior affecting the at least one potential current transaction.

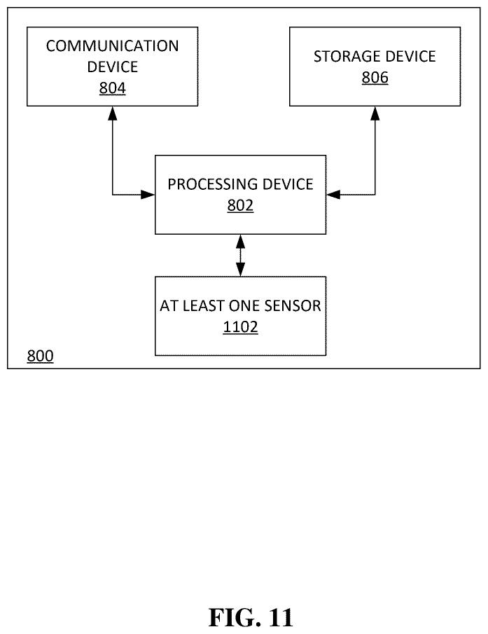

In an embodiment, the system 800 may include at least one sensor 1102, as shown in FIG. 11. Further, the at least one sensor 1102 may be communicatively coupled with the processing device 802. Further, the at least one sensor 1102 may be configured for detecting at least one of a physiological response, a physical response, and an emotional response of the at least one user while requesting the at least one potential current transaction. Further, the processing device 802 may be further configured for generating at least one sensor data based on the detecting of at least one of the physiological response, the physical response, and the emotional response. Further, the processing device 802 may be configured for analyzing the at least one sensor data. Further, the obtaining of the at least one behavior data may be based on the analyzing of the at least one sensor data. Further, the obtaining of the at least one behavior data may include generating the at least one behavior data.

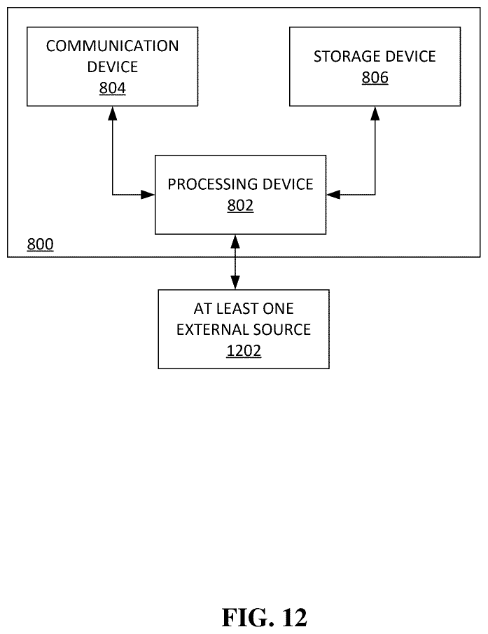

Further, in an embodiment, the processing device 802 may be further configured for extracting at least one user data from at least one external source 1202, as shown in FIG. 12. Further, the processing device 802 may be configured for analyzing the at least one user data. Further, the obtaining of the at least one behavior data may be based on the analyzing of the at least one user data. Further, the obtaining of the at least one behavior data may include generating of the at least one behavior data.

Further, in some embodiments, the processing device 802 may be further configured for determining at least one corrective action required for mitigating the at least one behavioral bias in the portfolio based on the analyzing of the at least one behavioral bias data, and investor behavior impact. Further, the processing device 802 may be configured for performing the at least one corrective action based on the determining of the at least one corrective action. Further, the at least one corrective action may include one or more of removing one or more financial instruments from a financial instrument listing available to a user associated with the portfolio and restricting an amount of one or more investments to a specific amount in the one or more financial instruments.

FIG. 9 is a block diagram of the system 800, in accordance with some embodiments.

FIG. 10 is a block diagram of the system 800, in accordance with some embodiments.

FIG. 11 is a block diagram of the system 800, in accordance with some embodiments.

FIG. 12 is a block diagram of the system 800, in accordance with some embodiments.

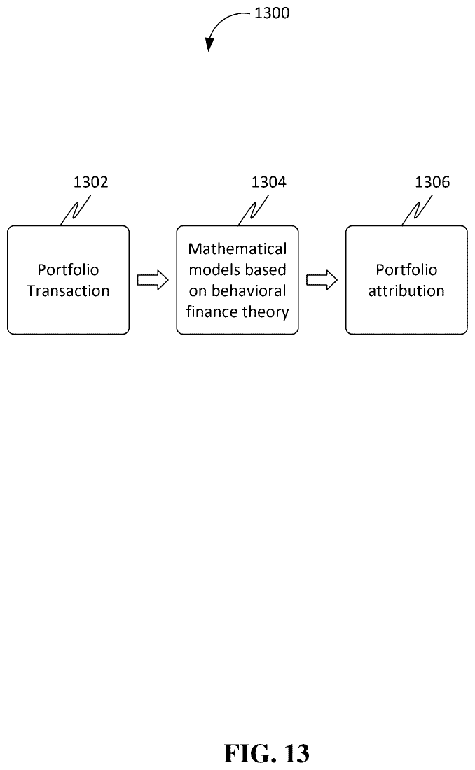

FIG. 13 is a flow diagram of a method 1300 of facilitating managing a performance of a portfolio, in accordance with some embodiments. Further, the method 1300 may include a step 1302 of inputting portfolio transactions to mathematical models 1304. Further, the mathematical models 1304 may be based on the behavioral finance theory. Further, the method 1300 may include a step 1306 of outputting portfolio attribution.

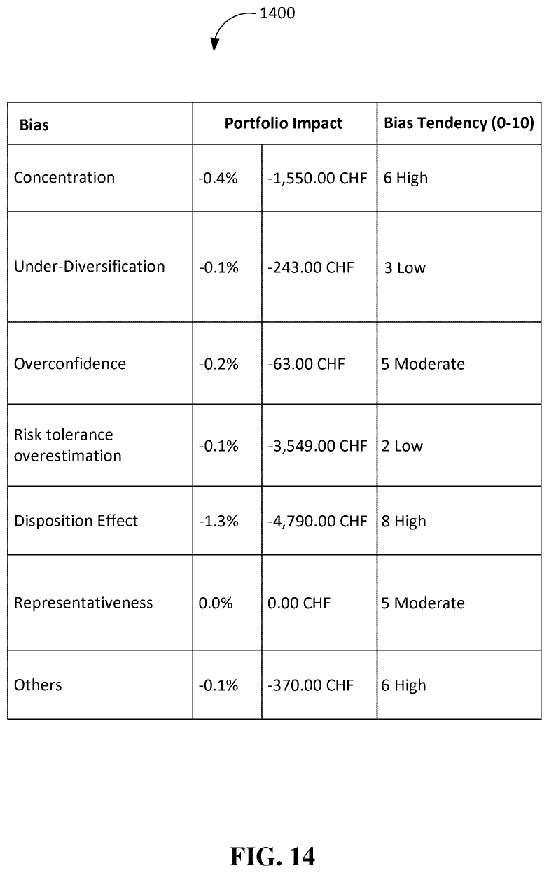

FIG. 14 illustrates a table 1400 of a performance report of the portfolio, in accordance with some embodiments.

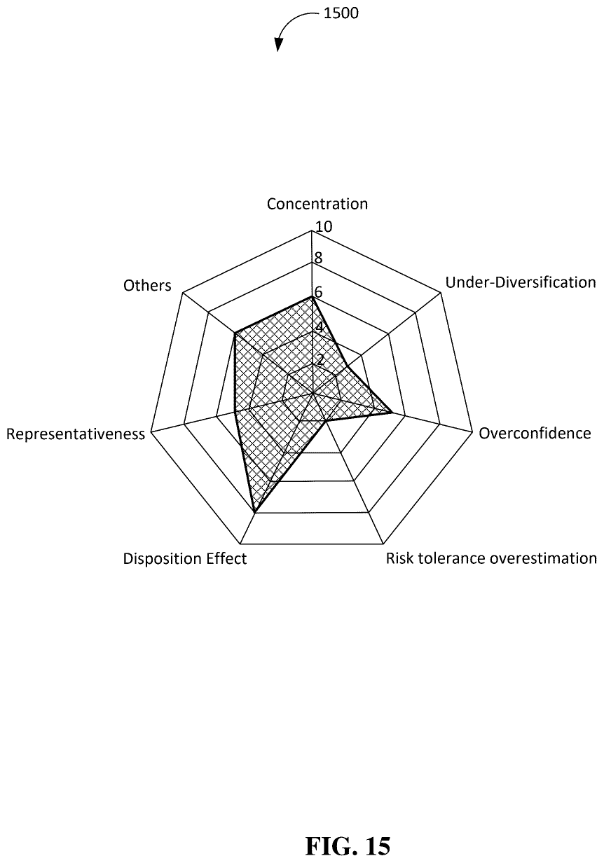

FIG. 15 illustrates a spider graph 1500 of the performance report of the portfolio, in accordance with some embodiments.

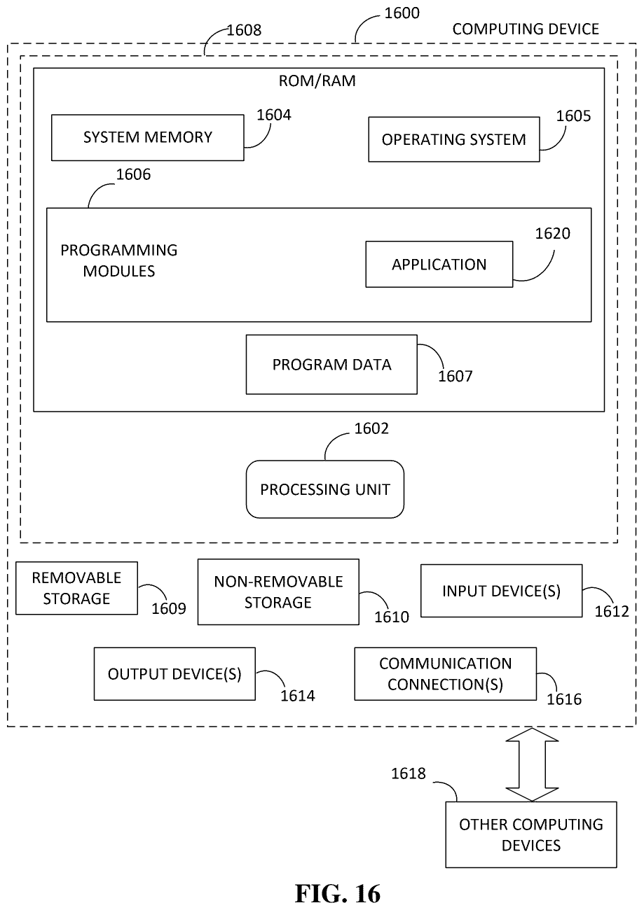

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable, and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method of facilitating managing a performance of a portfolio, the method comprising:
receiving, using a communication device, one or more embodied characteristics from one or more biometric sensors comprised in at least one user device to perform authentication of at least one user, wherein the one or more embodied characteristics is unique to the at least one user, wherein the one or more embodied characteristics is one or more biometric variables of the at least one user:
obtaining, using a processing device, at least one historical transaction data of at least one historical transaction associated with a portfolio from the at least one user device. wherein the obtaining of the at least one historical transaction data is initiated based on a control input received from the at least one user device, wherein the control input becomes effective for initiating the obtaining of the at least one historical transaction data upon a successful authentication of the at least one user;
analyzing, using the processing device, the at least one historical transaction data using at least one mathematical model, wherein the at least one mathematical model is based on a behavioral finance theory, wherein the at least one mathematical model is at least one recurrent neural network (RNN), wherein the at least one RNN is configured for quantifying an impact of at least one behavioral bias on the performance of the portfolio, wherein the at least one behavioral bias corresponds to at least one behavioral trait, wherein the analyzing of the at least one historical transaction data comprises executing the at least one RNN by inputting the at least one historical transaction data, wherein the at least one RNN is trained for detecting at least one pattern in the at least one historical transaction data indicative of a presence of the at least one behavioral bias, and at least one pattern characteristic of the at least one pattern indicative of a characteristic of the at least one behavioral bias, wherein the impact of the at least one behavioral bias is quantified based on the presence of the at least one behavioral bias and the characteristic of the at least one behavioral bias, wherein the at least one RNN is trained based on at least one training data using a supervised training method;
generating, using the processing device, at least one behavioral bias data corresponding to the at least one behavioral bias associated with the portfolio based on the analyzing of the at least one historical transaction data, wherein the generating of the at least one behavioral bias data is further based on the detecting the at least one pattern and the at least one pattern characteristic, wherein each of the at least one behavioral bias data comprises at least one index corresponding to the at least one behavioral bias. wherein each of the at least one index takes a value ranging between 0 and 1 for each of the at least one behavioral bias respectively, wherein the value of each of the at least one index indicates a degree of a strength of each of the at least one behavioral bias in the portfolio;
analyzing, using the processing device, the at least one behavioral bias data;
generating, using the processing device, an investor behavior impact on the performance of the portfolio based on the analyzing of the at least one behavioral bias data, and at least one additional data, wherein the investor behavior impact comprised of at least one investor behavior impact portion associated with the at least one behavioral bias;
generating, using the processing device, a performance report of the performance of the portfolio based on the investor behavior impact;
transmitting, using the communication device, the performance report to at least one device;
storing, using a storage device, the at least one mathematical model and the at least one additional data;
determining, using the processing device, at least one corrective action required for mitigating the at least one behavioral bias in the portfolio based on the analyzing of the at least one behavioral bias data, and the investor behavior impact;
communicating, using the communication device, one or more sensors associated with one or more contextual variables, wherein the one or more sensors comprise each of a timing device, a location sensor, a biometric sensor, and a device state sensor, wherein the device state sensor comprises a power sensor, a switch-state sensor, and a usage sensor; and
performing, using the processing device, the at least one corrective action based on the determining of the at least one corrective action at a local computing device, wherein the at least one corrective action comprises one or more of removing one or more financial instruments from a financial instrument listing available to a user associated with the portfolio and restricting an amount of one or more investments to a specific amount in the one or more financial instruments, wherein the financial instrument listing comprises a list of a plurality of financial instruments listed on at least one application, wherein the at least one application is hosted on the local computing device, wherein the list provides a plurality of investment options for the at least one user through the plurality of financial instruments, wherein the list is dynamically updatable in real time, wherein the performing of the at least one corrective action comprises updating the list by at least one of removing the one or more financial instruments from the list and updating at least one amount limit for investing in the one or more financial instruments, wherein the at least one application comprises a web based application, wherein the performing of the at least one corrective action is initiated based on one or more predefined conditions. wherein the one or more predefined conditions is based on the one or more contextual variables, wherein the one or more contextual variables represent a condition relevant to the performing of the at least one corrective action, wherein the one or more contextual variables comprises a location, a time, an identity of the at least one user, wherein the one or more contextual variables comprises a physical state of the at least one user device.

2. (canceled)

3. (canceled)

4. The method of claim 1 further comprising determining, using the processing device, at least one effect of each of the at least one behavioral bias in the performance of the portfolio based on the analyzing of the at least one historical transaction data and the investor behavior impact for each of the at least one behavioral bias, wherein the generating of the performance report is further based on the at least one effect.

5. The method of claim 1 further comprising:
receiving, using the communication device, at least one potential current transaction data of at least one potential current transaction associated with the portfolio from the at least one user device associated with the at least one user, wherein the at least one potential current transaction is requested by the at least one user;
detecting, using at least one sensor, at least one of a physiological response, a physical response, and an emotional response of the at least one user while requesting the at least one potential current transaction, wherein the detecting is initiated based on the receiving of the at least one potential current transaction data, wherein at least one of the physiological response, the physical response, and the emotional response comprises at least one involuntary response, wherein the physiological response comprises a change in body temperature, wherein the physical response comprises a facial expression, wherein the emotional response comprises an increase in blood pressure, wherein the at least one sensor comprises a temperature sensor, a blood pressure sensor, and a visible light sensor;
generating, using the processing device, at least one sensor data based on the detecting of at least one of the physiological response, the physical response, and the emotional response;
analyzing, using the processing device, the at least one sensor data;
obtaining, using the processing device, at least one behavior data of at least one behavior of the at least one user, associated with the at least one potential current transaction based on the analyzing of the at least one sensor data;
analyzing, using the processing device, the at least one potential current transaction data using at least one first model, wherein the at least one first model is configured for quantifying an impact of the at least one potential current transaction on the at least one behavioral bias in the portfolio;
analyzing, using the processing device, the at least one behavior data using at least one second model, wherein the at least one second model is further configured for quantifying an impact of the at least one behavior associated with the at least one potential current transaction on the at least one behavioral bias in the portfolio;
determining, using the processing device, a contribution of the at least one potential current transaction in the investor behavior impact based on the quantifying of the impact of the at least one potential current transaction on the at least one behavioral bias, and the impact of the at least one behavior associated with the at least one potential current transaction on the at least one behavioral bias in the portfolio;
generating, using the processing device, a recommendation for the at least one potential current transaction based on the determining of the contribution; and
transmitting, using the communication device, the recommendation to the at least one user device.

6. (canceled)

7. The method of claim 5, wherein the analyzing of the at least one behavior data further comprises analyzing the at least one behavior data using at least one third model, wherein the analyzing of the at least one potential current transaction data further comprises analyzing of the at least one potential current transaction data using the at least one third model, wherein the at least one third model is configured for quantifying an impact of the at least one behavior on the at least one potential current transaction, wherein the method further comprises determining, using the processing device, a likelihood of the at least one behavior affecting the at least one potential current transaction based on the quantifying of the impact of the at least one behavior on the at least one potential current transaction on the at least one behavioral bias in the portfolio, wherein the generating of the recommendation is further based on the determining of the likelihood of the at least one behavior affecting the at least one potential current transaction.

8. (canceled)

9. The method of claim 1 further comprising:
extracting, using the processing device, at least one user data from at least one external source; and
analyzing, using the processing device, the at least one user data, wherein the obtaining of the at least one behavior data is based on the analyzing of the at least one user data, wherein the obtaining of the at least one behavior data comprises generating of the at least one behavior data.

10. (canceled)

11. A system for facilitating managing a performance of a portfolio, the system comprising:
a processing device configured for;
obtaining at least one historical transaction data of at least one historical transaction associated with a portfolio from at least one user device, wherein the obtaining of the at least one historical transaction data is initiated based on a control input received from the at least one user device, wherein the control input becomes effective for initiating the obtaining of the at least one historical transaction data upon a successful authentication of at least one user;
analyzing the at least one historical transaction data using at least one mathematical model, wherein the at least one mathematical model is based on a behavioral finance theory, wherein the at least one mathematical model is at least one recurrent neural network (RNN), wherein the at least one RNN is configured for quantifying an impact of at least one behavioral bias on the performance of the portfolio wherein the at least one behavioral bias corresponds to at least one behavioral trait, wherein the analyzing of the at least one historical transaction data comprises executing the at least one RNN by inputting the at least one historical transaction data, wherein the at least one RNN is trained for detecting at least one pattern in the at least one historical transaction data indicative of a presence of the at least one behavioral bias, and at least one pattern characteristic of the at least one pattern indicative of a characteristic of the at least one behavioral bias, wherein the impact of the at least one behavioral bias is quantified based on the presence of the at least one behavioral bias and the characteristic of the at least one behavioral bias, wherein the at least one RNN is trained based on at least one training data using a supervised training method;
generating at least one behavioral bias data corresponding to the at least one behavioral bias associated with the portfolio based on the analyzing of the at least one historical transaction data, wherein the generating of the at least one behavioral bias data is further based on the detecting the at least one pattern and the at least one pattern characteristic, wherein each of the at least one behavioral bias data comprises at least one index corresponding to the at least one behavioral bias, wherein each of the at least one index takes a value ranging between 0 and 1 for each of the at least one behavioral bias respectively, wherein the value of each of the at least one index indicates a degree of a strength of each of the at least one behavioral bias in the portfolio;
analyzing the at least one behavioral bias data;
generating an investor behavior impact on the performance of the portfolio based on the analyzing of the at least one behavioral bias data, and at least one additional data, wherein the investor behavior impact comprised of at least one investor behavior impact portion associated with the at least one behavioral bias;
generating a performance report of the performance of the portfolio based on the investor behavior impact;
determining at least one corrective action required for mitigating the at least one behavioral bias in the portfolio based on the analyzing of the at least one behavioral bias data, and the investor behavior impact; and
performing the at least one corrective action based on the determining of the at least one corrective action at a local computing device, wherein the at least one corrective action comprises one or more of removing one or more financial instruments from a financial instrument listing available to a user associated with the portfolio and restricting an amount of one or more investments to a specific amount in the one or more financial instruments, wherein the financial instrument listing comprises a list of a plurality of financial instruments listed on at least one application, wherein the at least one application is hosted on the local computing device, wherein the list provides a plurality of investment options for the at least one user through the plurality of financial instruments, wherein the list is dynamically updatable in real time, wherein the performing of the at least one corrective action comprises updating the list by at least one of removing the one or more financial instruments from the list and updating at least one amount limit for investing in the one or more financial instruments, wherein the at least one application comprises a web based application wherein the performing of the at least one corrective action is initiated based on one or more predefined conditions, wherein the one or more predefined conditions is based on one or more contextual variables, wherein the one or more contextual variables represent a condition relevant to the performing of the at least one corrective action, wherein the one or more contextual variables comprises a location, a time, an identity of the at least one user, wherein the one or more contextual variables comprises a physical state of the at least one user device;
a communication device communicatively coupled with the processing device, wherein the communication device is configured for;
receiving one or more embodied characteristics from one or more biometric sensors comprised in the at least one user device to perform authentication of the at least one user, wherein the one or more embodied characteristics is unique to the at least one user, wherein the one or more embodied characteristics is one or more biometric variables of the at least one user;
communicating one or more sensors associated with the one or more contextual variables, wherein the one or more sensors comprise each of a timing device, a location sensor, a biometric sensor, and a device state sensor, wherein the device state sensor comprises a power sensor, a switch-state sensor, and a usage sensor; and
transmitting the performance report to at least one device; and
a storage device communicatively coupled with the processing device, wherein the storage device is configured for storing the at least one mathematical model and the at least one additional data.

12. (canceled)

13. (canceled)

14. The system of claim 11, wherein the processing device is further configured for determining at least one effect of each of the at least one behavioral bias in the performance of the portfolio based on the analyzing of the at least one historical transaction data and the investor behavior impact for each of the at least one behavioral bias, wherein the generating of the performance report is further based on the at least one effect.

15. The system of claim 11, wherein the communication device is further configured for:
receiving at least one potential current transaction data of at least one potential current transaction associated with the portfolio from the at least one user device associated with the at least one user, wherein the at least one potential current transaction is requested by the at least one user; and
transmitting a recommendation to the at least one user device, wherein the system further comprises at least one sensor coupled with the processing device, wherein the at least one sensor is configured for detecting at least one of a physiological response, a physical response, and an emotional response of the at least one user while requesting the at least one potential current transaction, wherein the detecting is initiated based on the receiving of the at least one potential current transaction data, wherein at least one of the physiological response, the physical response, and the emotional response comprises at least one involuntary response, wherein the physiological response comprises a change in body temperature, wherein the physical response comprises a facial expression, wherein the emotional response comprises an increase in blood pressure, wherein the at least one sensor comprises a temperature sensor, a blood pressure sensor, and a visible light sensor, wherein the processing device is further configured for;
generating at least one sensor data based on the detecting of at least one of the physiological response, the physical response, and the emotional response;
analyzing the at least one sensor data;
obtaining at least one behavior data of at least one behavior of the at least one user. associated with the at least one potential current transaction based on the analyzing of the at least one sensor data;
analyzing the at least one potential current transaction data using at least one first model, wherein the at least one first model is configured for quantifying an impact of the at least one potential current transaction on the at least one behavioral bias in the portfolio;
analyzing the at least one behavior data using at least one second model, wherein the at least one second model is further configured for quantifying an impact of the at least one behavior associated with the at least one potential current transaction on the at least one behavioral bias in the portfolio;
determining a contribution of the at least one potential current transaction in the investor behavior impact based on the quantifying of the impact of the at least one potential current transaction on the at least one behavioral bias, and the impact of the at least one behavior associated with the at least one potential current transaction on the at least one behavioral bias in the portfolio; and
generating the recommendation for the at least one potential current transaction based on the determining of the contribution.

16. (canceled)

17. The system of claim 15, wherein the analyzing of the at least one behavior data further comprises analyzing the at least one behavior data using at least one third model, wherein the analyzing of the at least one potential current transaction data further comprises analyzing of the at least one potential current transaction data using the at least one third model, wherein the at least one third model is configured for quantifying an impact of the at least one behavior on the at least one potential current transaction, wherein the processing device is further configured for determining a likelihood of the at least one behavior affecting the at least one potential current transaction based on the quantifying of the impact of the at least one behavior on the at least one potential current transaction on the at least one behavioral bias in the portfolio, wherein the generating of the recommendation is further based on the determining of the likelihood of the at least one behavior affecting the at least one potential current transaction.

18. (canceled)

19. The system of claim 11, wherein the processing device is further configured for;
extracting at least one user data from at least one external source; and
analyzing the at least one user data, wherein the obtaining of the at least one behavior data is based on the analyzing of the at least one user data, wherein the obtaining of the at least one behavior data comprises generating of the at least one behavior data.

20. (canceled)
